(19) United States
(12) Patent Application Publication
(10) Pub. No.: US 2011/0285862 A1
(43) Pub. Date: Nov. 24, 2011

(54) METHOD AND APPARATUS FOR PROVIDING WEB CAMERA SERVICE IN A PORTABLE TERMINAL

(75) Inventors: Dong-Hoon KIM, Seoul (KR); Cheol-Ho CHEONG, Seoul (KR)

(73) Assignee: SAMSUNG ELECTRONICS CO., LTD., Gyeonggi-Do (KR)

(21) Appl. No.: 13/107,186

(22) Filed: May 13, 2011

(30) Foreign Application Priority Data
May 18, 2010 (KR) 10-2010-0046300

(51) Int. Cl. H04N 5/225

(52) U.S. Cl. 348/207.1; 348/E05.024

(57) ABSTRACT

A method and apparatus for providing a Web camera service in a portable terminal are provided. A method for providing a Web camera service in a portable terminal preferably includes detecting connection with an external device, entering a Web camera mode, setting the kind (type) of an image to be transmitted to the connected external device, and transmitting, to the external device, at least one of a camera image and an image for storage contents according to the set kind.

### CLAIM OF PRIORITY

This application claims priority under 35 U.S.C. §119(a) from a Korean Patent Application Serial No. 10-2010-0046300 filed in the Korean Intellectual Property Office on May 18, 2010, the contents of which are herein incorporated by reference in its entirety.

### BACKGROUND OF THE INVENTION

1. Field of the Invention

The present invention relates to a Web camera service in a portable terminal. More particularly, the present invention relates to a method and apparatus for a portable terminal operates as a Web camera for an external device, and transmits an image to the external device.

2. Description of the Related Art

In recent years, various programs supporting video calls between users in a computer system are being developed. For instance, messenger services enabling conversation through video calls are being provided in addition to the functions associated with conversation using a text or image between users.

The programs supporting the video call require separate equipment called a Web camera, but most users do not have a separate Web camera due to cost side and the like. On the other hand, not all portable terminals have a digital camera function. Accordingly, the recent scheme using a camera of the portable terminal as a Web camera is being provided. For example, a scheme is being provided in which, if the portable terminal couples to a computer system through a Universal Serial Bus (USB), the portable terminal transmits, to the computer system, an image signal input from a camera installed in the portable terminal, whereby the computer system displays the image signal or transmits the image signal to other computer system(s) that is in video call.

The above scheme transmits an image signal, which is input through a camera in a portable terminal, to a computer system through a USB. That is, the conventional scheme cannot meet user demand desiring much various functions, because it may transmit only the image signal input from the camera in the portable terminal, to the computer system.

### SUMMARY OF THE INVENTION

An exemplary aspect of the present invention is to substantially solve at least the above problems and/or disadvantages and to provide at least the advantages below. Accordingly, one exemplary aspect of the present invention is to provide an apparatus and method for providing a Web camera service in a portable terminal.

Another exemplary aspect of the present invention is to provide an apparatus and method for transmitting an image to an external device in the case of operating a Web camera for the external device in a portable terminal.

A further exemplary aspect of the present invention is to provide an apparatus and method for transmitting, to an external device, an image or multimedia contents input from a camera according to user's selection during Web camera service for the external device in a portable terminal.

Yet another exemplary aspect of the present invention is to provide a method and apparatus for combining an image input from a camera with a previously stored image and transmitting the combined image to an external device during Web camera service for the external device in a portable terminal.

The above exemplary aspects are achieved by providing a method and apparatus for providing a Web camera service in a portable terminal.

According to one exemplary aspect of the present invention, a method for providing a Web camera service in a portable terminal is provided. The method includes detecting connection with an external device, entering a Web camera mode, setting the kind of an image to be transmitted to the connected external device, and transmitting, to the external device, at least one of a camera image and an image for storage contents according to the set kind.

According to another exemplary aspect of the present invention, an apparatus for providing a Web camera service in a portable terminal is provided. The apparatus includes a camera, a storage unit, a controller, and a communication unit. The camera acquires an image. The storage unit stores contents. The controller detects connection with an external device, enters a Web camera mode, and sets the kind of an image to be transmitted to the connected external device. The communication unit transmits, to the external device, at least one of a camera image and an image for storage contents according to the control of the controller.

Other exemplary aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of the present invention will become more apparent to a person of ordinary skill in the art from the following detailed description when taken in conjunction with the accompanying drawings in which:

FIG. 1 is a diagram illustrating an example of a system construction providing a Web camera service using a portable terminal according to the present invention;

FIG. 2 is a block diagram illustrating a construction of a portable terminal according to an exemplary embodiment of the present invention; and

FIG. 3 is a flowchart illustrating a procedure of providing a Web camera service in a portable terminal according to an exemplary embodiment of the present invention.

### DETAILED DESCRIPTION

Preferred exemplary embodiments of the present invention will be described herein below with reference to the accompanying drawings. In the following description, well-known functions or constructions may not be described in detail since when their inclusion would obscure appreciation of the present invention by a person of ordinary skill in the art with unnecessary descriptions of well-known functions or constructions.

Below, exemplary embodiments of the present invention provide a method and apparatus for a portable terminal operating as a Web camera for an external device by transmitting an image to the external device. Here, the external device means Mobile Stations (MSs) with computer systems. Below, a description is made by way of a Personal Computer (PC) in the exemplary embodiments of the present invention. Also, here, the portable terminal and the external device may wireless or wired connect with each other. The following description is made by way of Universal Serial Bus (USB) connection but the presently claimed invention is not limited thereto.

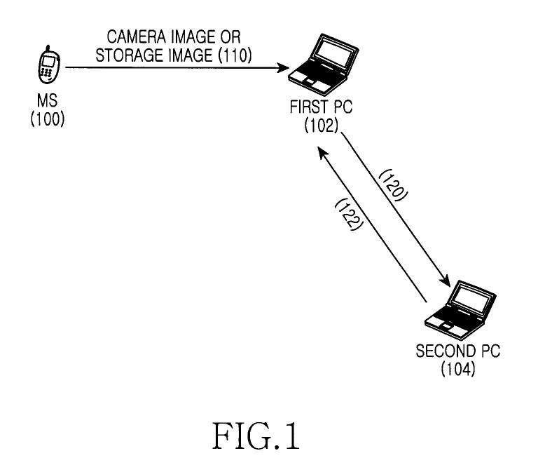

FIG. 1 illustrates a system construction providing a Web camera service using a portable terminal according to the present invention.

Referring now to FIG. 1, when an MS 100 couples with a first PC 102 through a USB, the MS 100 enters a Web camera mode according to user selection. Here, the Web camera mode means that the portable terminal operates as a Web camera for an external device.

The MS 100, when entering the Web camera mode, transmits a selected image from among a current camera image and a previously-stored image from a user. The MS 100 transmits an image signal input from a camera provided in the MS 100 to the first PC 102 or transmits an image signal for previously stored multimedia contents to the first PC 102 according to a user setup. For example, the MS 100 may combine the image signal input from the camera with the image signal for the previously-stored multimedia contents according to user setup and transmit the combined image to the first PC 102. Moreover, according to a conventional Picture In Picture (PIP) technique, the MS 100 combines the image signal input from the camera with the image signal for the multimedia contents and transmit the combined image to the first PC 102.

Then, the first PC 102 processes an image signal received from the MS 100 and displays the image signal on a screen while, as shown by arrow 120, transmits the received image signal to a second PC 104 being in video call. Also, as shown by arrow 122 in FIG. 1, the first PC 102 may receive an image signal from the second PC 104 and display the image signal on its own screen.

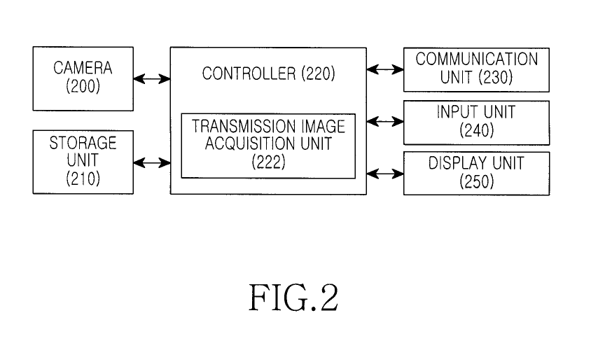

FIG. 2 illustrates a typical construction of a portable terminal according to an exemplary embodiment of the present invention. As illustrated in FIG. 2, the portable terminal preferably includes a camera 200, a storage unit 210, a controller 220, a communication unit 230, an input unit 240, and a display unit 250.

First, the controller 220, which is typically a processor or microprocessor, controls and processes the general operation of the portable terminal, and controls and processes a function for, upon coupling with a PC through, for example a USB, entering a Web camera mode for the PC according to user selection and transmitting an image signal to the PC. That is, when the portable terminal couples with the PC through the USB, the controller 220 determines whether the Web camera mode is selected by a user. The Web camera mode may be selected through a specific key or menu of the input unit 240. If the Web camera mode is selected, the controller 220 displays a screen utilized for setting the kind of a transmission image on the display unit 250, identifying the kind of a transmission image set by the user, and acquiring a transmission image corresponding to the identified kind through a transmission image acquisition unit 222. Here, the kind of the transmission image may be divided into an image input from a camera and an image for multimedia contents previously stored in the storage unit 210 of the MS.

The transmission image acquisition unit 222 acquires a corresponding image signal from the camera 200 or storage unit 210 according to the kind (type) of the transmission image. In other words, when the type of the transmission image is a camera image, the transmission image acquisition unit 222 drives the camera 200 and acquires an image input from the camera 200. Also, when the type of the transmission image is an image for previously-stored multimedia contents, the transmission image acquisition unit 222 searches the multimedia contents previously-stored in the storage unit 210, provides a list of the searched multimedia contents to the display unit 250, and receives a signal of informing that at least one piece of multimedia contents is selected from among the searched multimedia contents, from the input unit 240. The transmission image acquisition unit 222 reads out the selected multimedia contents from the storage unit 210 and decodes the read-out multimedia contents. Here, the multimedia contents may comprise a moving image or a still image. Here, when the multimedia contents are a moving image, the transmission image acquisition unit 222 may acquire a decoded image signal for the moving image through a moving image playback program previously stored in the MS.

Also, if an image signal is acquired through the transmission image acquisition unit 222, the controller 220 generates a packet including the image signal based on a USB standard that is a connection (coupling) scheme of the MS and a PC, and provides the packet to the communication unit 230. Here, when the MS and the PC connect with each other in a different connection scheme, the controller 220 may generate a packet including the image signal based on a standard of the corresponding connection scheme.

Also, when two or more types of image signals are acquired through the transmission image acquisition unit 222, the controller 220 may combine and process these images such that the two or more kinds of image signals provided may be displayed on one screen. For example, when an image signal input through the camera 200 and an image signal for multimedia contents previously-stored in the storage unit 210 are simultaneously acquired, the controller 220 may combine the acquired camera image signal with the image signal for multimedia contents according to the PIP function well known in the art.

The camera 200 operates by the control of the transmission image acquisition unit 220 and performs image capturing. The camera 200 preferably includes a camera sensor for converting an optical signal sensed at the image capturing into an electrical signal and a signal processor for converting an analog image signal captured from the camera sensor into digital data, thereby converting the captured image signal into digital data and providing the digital data to the transmission image acquisition unit 220.

The storage unit 210 preferable comprises a non-transitory machine readable medium that stores various kinds of programs and data necessary for an operation of the portable terminal. Particularly, the storage unit 210 stores various kinds of multimedia contents according to user's control. For example, the storage unit 210 may store a moving image and a still image.

The communication unit 230 transmits/receives a signal with a wireless or wired connected external device according to the control of the controller 220. Particularly, the communication unit 230 transmits a packet including an image signal to a PC connected by a USB according to an exemplary embodiment of the present invention.

The input unit 240 preferably includes a keypad including at least one function key and a touch sensor. The input unit 240 receives a selection of Web camera mode entry, the kind of a transmission image, and multimedia contents to be transmitted from a user and provides to the controller 220. The input unit and the display unit could also comprise a single touchscreen with a virtual keypad.

The display unit 250 displays status information generated during an operation of the portable terminal, the limited number of numerals and characters, a moving image, a still image, and the like. Particularly, the display unit 250 displays an image signal acquired in the transmission image acquisition unit 220 according to the control of the controller 220, and displays a screen for requesting for setting the type of a transmission image and a screen for requesting the setting of multimedia contents corresponding to an image to be transmitted.

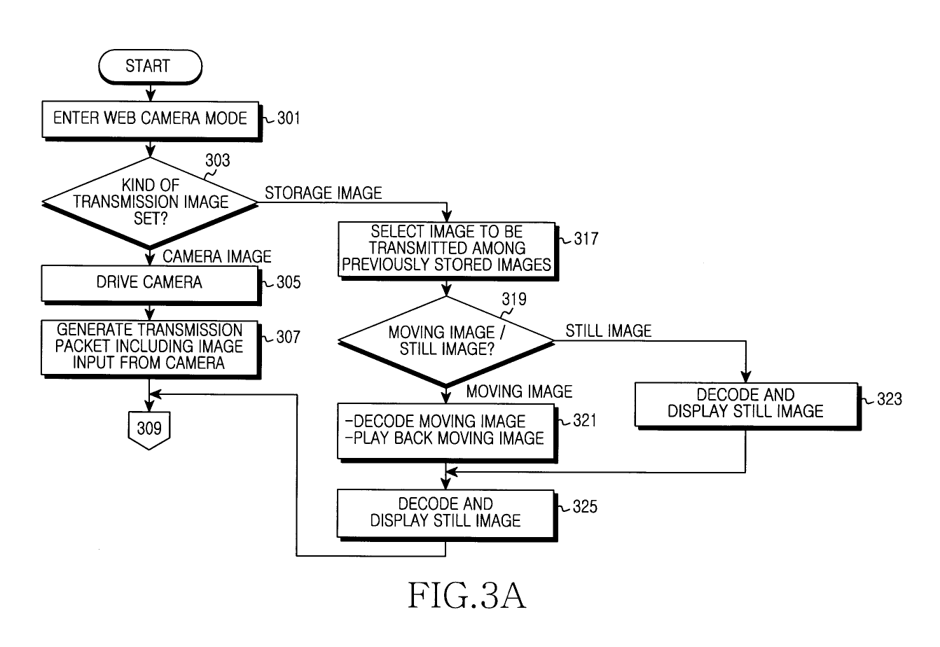

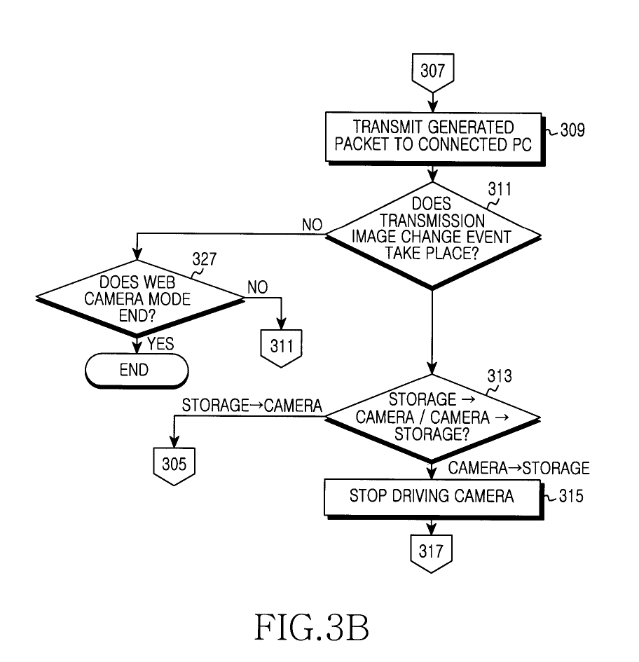

FIG. 3 illustrates a procedure of providing a Web camera service in a portable terminal according to an exemplary embodiment of the present invention.

Referring now to FIGS. 3A and 3B, if the MS enters a Web camera mode in step 301, the MS proceeds to step 303 and displays a screen for requesting for setting the kind (i.e. type) of a transmission image and determines the kind of a transmission image set by a user. Here, the Web camera mode may be enabled by user's key manipulation after the MS is wireless or wired connected with an external device such as a PC. The kind of the transmission image may be divided into a camera image and a storage image.

When the camera image is set as an image to be transmitted, at step 305 the MS drives a camera. Subsequently, at step 307 the MS generates a transmission packet including an image input from a camera. At this time, the transmission packet is generated based on a standard of a connection scheme of the MS and the PC. For example, when the MS and the PC connect with each other by a USB, the transmission packet is generated by a USB standard. After that, the MS performs step 309 where the generated packet is transmitted to the connected PC.

On the other hand, when the storage image is set as the image to be transmitted, in step 317, the MS selects an image to be transmitted from among previously stored images according to user control. For example, the MS search multimedia contents previously stored in a storage unit of the MS, display a list representing the searched multimedia contents on a screen, and receive a selection of one piece of multimedia contents from a user.

After that, in step 319, the MS determines if the selected transmission image is a moving image or a still image. When the selected transmission image is the moving image, in step 321, the MS decodes the selected moving image, plays back the moving image through a moving image playback program, and displays the moving image on the screen. When the selected transmission image is a still image, in step 323, the MS decodes the selected still image and displays the still image on the screen.

Next, in step 325, the MS generates a transmission packet including a decoded image and then, proceeds to step 309 below. At this time, the transmission packet is generated based on the standard of the connection scheme of the MS and PC. For example, when the MS and the PC connect with each other by the USB, the transmission packet is generated according to the USB standard.

After that, in step 309, the MS transmits the generated transmission packet to the connected PC and, in step 311, determines if a transmission image change event takes place.

If the transmission image change event takes place, in step 313, the MS determines if the transmission image changes from a storage image to a camera image or determines if the transmission image changes from the camera image to the storage image. When the transmission image changes from the camera image to the storage image, in step 315, the MS stops driving the camera and, in step 317, the MS performs the subsequent steps. On the other hand, when the transmission image changes from the storage image to the camera image, the MS proceeds to step 305 and performs the subsequent steps.

On the other hand, when the transmission image change event does not take place, in step 327, the MS determines if the Web camera mode ends. When the Web camera mode does not end, the MS then returns to step 311 and again performs the subsequent steps. When the Web camera mode ends, the MS terminates the procedure according to the exemplary embodiment of the present invention.

In FIG. 3, for the sake of description convenience, the transmitting of only one type of image to an external device in the portable terminal is described, but two types of images may be transmitted to the external device in the portable terminal. For example, the portable terminal may combine an image acquired from a camera with an image for previously stored multimedia contents according to a PIP technique and transmit the combined image to the external device. In more detail, after the portable terminal may reduce an image acquired from a camera or select only a predetermined image region and reduce an image for the previously stored multimedia contents or select only a predetermined image region, and then combine the two images and transmit the combined image to the external device. Through this invention, the portable terminal may adapt a decoded image to a frame, and allow the image from the camera to be displayed within the frame.

Also, the portable terminal may give display order to each frame of the image acquired from the camera and the image for the previously stored multimedia contents, and then transmit to the external device.

Also, according to the present invention, the portable terminal may combine images for at least two pieces of multimedia contents with each other and transmit the combined image to the external device. For example, the portable terminal may combine one still image with one moving image, combine two still images, or combine two moving images. At this time, the display position and order of the combined two images may be set by a user.

Exemplary embodiments of the preset invention have an advantageous effect that, by transmitting an image input from a camera and/or a previously stored image to an external device according to user selection during Web camera service for the external device in a portable terminal, a user being in video call may transmit multimedia contents to a called user through the external device and also, may combine the image input from the camera with an image for multimedia contents and apply the combined image to various applications. The above-described methods according to the present invention can be implemented in hardware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for providing a Web camera service in a portable terminal, the method comprising:
detecting by a controller a connection with an external device;
entering a Web camera mode by the controller;
setting the type of an image to be transmitted to the connected external device; and
transmitting by a communication unit to the external device, at least one of a camera image and an image for storage contents according to the set type.

2. The method of claim 1, wherein the type of the image to be transmitted comprises at least one of an image input from a camera and an image for contents previously stored in a storage unit of the Mobile Station (MS).

3. The method of claim 2, wherein transmitting at least one to the external device according to the set type comprises:
when the set type of the transmission image comprises the image input from the camera, acquiring an image through the camera provided in the MS; and
generating by the controller a packet comprising the acquired image and transmitting the packet to the external device.

4. The method of claim 2, wherein transmitting by the communication unit at least one image to the external device according to the set type comprises:
when the set type of the transmission image is the image for the previously stored contents, displaying a list of the contents previously-stored in the MS;
selecting at least one piece of contents from the list of the contents;
decoding the selected at least one piece of contents; and
generating a packet comprising the decoded image and transmitting the packet to the external device.

5. The method of claim 2, wherein transmitting at least one image to the external device according to the set type comprises:
when the set type of the transmission image represents a combination of the image input from the camera and the image for the previously-stored contents, acquiring an image through the camera provided in the MS;
selecting at least one piece of contents from among the contents previously-stored in the MS;
decoding the selected at least one piece of contents; and
generating a packet comprising the image acquired through the camera and the decoded image, and transmitting the packet to the external device.

6. The method of claim 5, wherein the image acquired through the camera and the decoded image are processed according to a Picture-In-Picture (PIP) technique.

7. The method of claim 5, further comprising determining the display order and position of the image acquired through the camera and the decoded image.

8. The method of claim 7, wherein a display order and position are settable and changeable by a user.

9. An apparatus for providing a Web camera service in a portable terminal, the apparatus comprising:
a camera for acquiring an image;
a storage unit for storing contents;
a controller for detecting connection with an external device, entering into a Web camera mode, and setting the type of an image to be transmitted to the connected external device; and
a communication unit for transmitting to the external device at least one of a camera image and an image for storage contents according to the control of the controller.

10. The apparatus of claim 9, wherein the type of the image to be transmitted comprises at least one of an image input from a camera and an image for contents previously-stored in a Mobile Station (MS).

11. The apparatus of claim 10, wherein when the set type of the transmission image is the image input from the camera, the controller acquires an image through the camera provided in the MS, generates a packet comprising the acquired image, and transmits the packet to the communication unit.

12. The apparatus of claim 10, further comprising a display unit for displaying a list of the contents previously stored in the MS,
wherein, when the set type of the transmission image is the image for the previously-stored contents, the controller selects at least one piece of contents from the list of the contents, decodes the selected at least one piece of contents, generates a packet comprising the decoded image, and transmits the packet to the communication unit.

13. The apparatus of claim 10, further comprising a display unit for displaying a list of the contents previously stored in the MS,
wherein, when the set type of the transmission image represents a combination of the image input from the camera and the image for the previously stored contents, the controller acquires an image through the camera provided in the MS, selects at least one piece of contents from among the contents previously stored in the MS, decodes the selected at least one piece of contents, and generates a packet comprising the image acquired through the camera and the decoded image.

14. The apparatus of claim 13, wherein the controller processes the image acquired through the camera and the decoded image according to a Picture-In-Picture (PIP) technique.

15. The apparatus of claim 13, wherein the controller determines a display order and position of the image acquired through the camera and the decoded image.

16. The apparatus of claim 15, wherein the display order and position are settable and changeable by a user.

17. A portable terminal for providing a multiple image web camera function, said portable terminal comprising:
a controller;
an RF communication unit for wireless communication with a base station via a first frequency, and for coupling with an external device via a second frequency;
a camera for acquiring a current image;
a memory for storing a previously-acquired image; and
wherein the controller retrieves the previously acquired image from memory and combines the previously acquired image with the current image for transmission via the RF communication unit.

18. The portable terminal according to claim 17, further comprising a touchscreen, and wherein the previously acquired image comprises a moving image that is user selected by a touchscreen.

19. The portable terminal of claim 18, wherein the controller combines for transmission less than an entire portion of the currently acquired image by the camera or less than an entire portion of the previously acquired image from the memory.

20. The portable terminal of claim 17, wherein the portable terminal adapts a decoded image from memory to a frame, and controls the currently acquired image from the camera to be displayed within said frame.
